(19) United States
(12) Patent Application Publication
(10) Pub. No.: US 2005/0120084 A1
(43) Pub. Date: Jun. 2, 2005

(54) Method of and system for creating, maintaining, and utilizing an online universal address book

(76) Inventors: Yu Hu, Mystic, CT (US); Dan Qiu, Shanghai (CN)

Correspondence Address: Yu Hu, 117 Deerfield Ridge Drive, Mystic, CT, 06355, US

(21) Appl. No.: 10/973,283

(22) Filed: Oct. 27, 2004

Related U.S. Application Data
(60) Provisional application No. 60/515,105, filed on Oct. 28, 2003.

(51) Int. Cl. G06F 15/16; G06F 7/00; G06F 17/30

(52) U.S. Cl. 709/206; 709/201; 707/10

(57) ABSTRACT

A method for creating and maintaining a social network system using a computer system includes constructing a first database for storing identification information and a second database for storing contact information of a user, the second database being connected to the first database; receiving registration from users in the computer system, the registration containing identification and contact information of the users; sending invitation initiated by a first user to a second user specified by the first user; if the second user accepts the invitation, creating a direct link between these two users, the direct link allowing the two users to access the other's contact information. The method may further include creating an address book containing identification information and contact information of users that are directly connected to a user A for the user A. Any amendment of the information of a user initiated by the user who is directly connected to user A will be reflected in user A's address book. The invention also provides a computer system for implementing the method for creating and maintaining the social network system.

### FIELD OF THE DISCLOSURE

The present disclosure relates to methods and systems for creating, maintaining, and utilizing an online social networking system, particularly to methods of and systems for creating, maintaining, and utilizing an online universal address book.

### BACKGROUND OF THE DISCLOSURE

Social networking websites have been emerging as one of the recent hot spots of the internet business. The general idea of online social networking is to create an Internet system connecting all the users of the system, and then utilizing this network to facilitate communications between the users.

Conventionally, everyone has an address book, which contains contact information of persons he/she would like to contact in the future. The address book can be in different formats, for example, a paper address book, a digital version saved in computer, Personal Digital Assistant (PDA), cell phone, or E-mail server. Some people have multiple address books in different forms. It is difficult and time consuming for a user to create and update or maintain these address books one by one for the following reasons:

Firstly, the conventional method of creating address books is time consuming. When the address book is created, the user has to manually input the address information into the address book, for example, inputting the address information into an address book saved in a computer. When a user creates a new address book, for example, in a new cell phone or PDA, the user has to input all the information again.

Secondly, it is very difficult for the user to keep all contact information up to date in all his/her address books. If the user doesn't update his/her address books frequently, he may lose some contact information.

Thirdly, the user's access to the conventional address books may be limited. For example, the user may lose or forget to bring his PDA or paper address book, and therefore, cannot get the needed information promptly.

Fourthly, it will be troublesome for a user (a person or a business entity) to keep all his/her friends or the related business entities informed of the user's new address when the user changes its address. For example, if the user has ten related business entities such as credit card companies, banks, cell phone providers etc., every time when the user moves to a new place, the user has to inform all these business entities of its new address.

Another traditional approach is to build an address book saved in a computer and synchronize other address books, for example, PDA or cell phone, with the address book saved in computer. But the user still needs to manually update this online address book frequently, because the contact information of the persons or the business entities whose address information is saved in this online address book may change.

The conventional address books waste resources such as storage space and update efforts, and cause redundant communication traffic. For instance, if there are n persons and each person stores the other (n−1) persons' information in his address book, the total disk space used to store n address books will be n(n−1) rows of data. And if one person's address changes, he has to communicate with the other (n−1) persons, therefore, the total network communication for n address changes will also be n(n−1). The storage space and maintaining time are wasted with the conventional address books.

What is needed therefore is a universal address book, which can be created easily, maintained with less storage space and less time consumed. and accessed conveniently.

### SUMMARY OF THE DISCLOSURE

The present disclosure provides a method and a system for creating, maintaining, and utilizing an online social networking system, which, in a preferred embodiment, is in a format of an online universal address book.

The online social networking system according to one preferred embodiment of the present invention includes a server and users, which communicate with the server over communication links, which may be any medium for transferring data between users and the server. The links may be secured or unsecured depending upon the requirements of a particular application.

In accordance with one preferred embodiment, a user, for example, User1, enters his own information which may include but not limited to contact information, photo, marital status, employment information, and etc., over the links, e.g. Internet, into the server. User2 and User3 may also, with or without User1's invitation, connect to the sever, and register on the server, entering their own contact information. Each registered user will have an ID, which can be chosen by the user or assigned by the server. The server automatically creates an address book for each registered user. A registered user (e.g. User1) can invite other registered users (e.g. User2 and User3) to be his “friends”, and upon the acceptance of User2 and User3, User2's and User3's ID will appear on User1's address book or “friend list”, and the IDs are preferably hyperlinked to the database where User2's and User3's registered information is stored. Then User2 and User3 are “directly connected” to User1. When User1 opens his online universal address book, User2's and User3's addresses will be automatically pulled out by server. User1's information is also in User2's and User3's address books in the server. Whenever a registered user, for example User 3, changes his contact information, such as changes a new phone or moves to a new place, he only needs to log into the server and update his own information. The new information of User3 will be automatically reflected in other users' address books, which are directly connected to User3, in the above described example, User1's address book. A user always can set up what information is visible to his directly connected “friends”, and what is invisible to the directly connected “friends”.

The user may have several other address books stored in his computer, laptop, PDA or smart cell phone, and he can synchronize these address books with the online universal address book stored in the server. The user can also query the information in his address book in server through email, PDA, cell phone or desk phone.

In the embodiment according to the present disclosure, the user does not need to enter and update his “friends'” information in his address book, but only needs to maintain his own contact information. His “friends'” contact information will be maintained by themselves and any update of their contact information will be reflected in the user's address book. Thus in the social networking system, a user, e.g. User1, can always have his most up to date contact information reflected on other directly connected users' address book, e.g. User2′ and User3′ address books, and vice versa, User1 can always have User2's and User3's up to date contact information in User1's address book. The address book server takes the user's address input into the database, establishes the connection between users, and presents the physical address data to the internet user whenever his address book is opened.

According to one preferred embodiment, the universal address book includes two tables to hold the data needed by all network users, one is an address table, and the other is an intersection table. The address table stores the physical address data of each user, and intersection table stores the relationship between the user and his friends. The user's IDs are saved in a column called the Per_ID column, and the user's friends IDs are saved in another column called Con_ID column. The intersection table is linked to the address table through communication links. The user's address book is just a presentation layer, and the address data comes from the connections saved in column 503 between the two tables. Each person's address is stored as one row in the address table no matter how big his friend group is. If a user adds or deletes a friend in his address book, two entries (mutual adding and deleting) will be created or deleted in the intersection table. For example, if A and B are directly connected, B is in A's address book and A can see B's address by clicking B's Con_ID in A's address book, and B also can see A's address by clicking A's Con_ID in B's address book. If A and B are not directly connected, neither A nor B can see the other's address information. The visibility is controlled by the entry in the intersection table. When A creates his address book, he adds B, C and D in his address book with their approval, so six blocks are created in the intersection table. While A browses his address book, the system will first query the intersection table, locate the row with Per_ID=‘A’, find the corresponding Con_ID, which are B,C and D in this case, then join with the address table, and finally, B, C and D's address will be provided in A's address book. A can always get B, C and D's most up to date addresses since the address data in the address table are maintained by B, C, D themselves, and generally each person will update his own contact information when changes happened. In order to maintain n address books among n friends, the two physical tables can be used to store n+n(n−1)=n² rows of data, among which n rows store the actual physical address data in the address table, and the other n(n−1) rows store the relationship among the users in the intersection table. Since the intersection table only stores pointers, the storage space is negligible compared to that consumed by the actual physical address data. Whenever one person changes his address, only one row of address data will be changed in the address table. Therefore, n rows in address table will be updated if everyone changes the address. In the other embodiments, more tables can be used for other considerations such as functionality and performance.

### BRIEF DESCRIPTION OF THE DRAWINGS

FIGS. 1A and 1B illustrate architectures of traditional address books;

FIG. 1C illustrates an architecture of an universal address book system according to one preferred embodiment of the present invention;

FIG. 2 is a graph representation of the address book network;

FIG. 3 is a flow diagram of a routine that a user creates and edits his address book;

FIG. 4A illustrates a flow diagram of the procedure that a user makes changes in his address book in the prior art;

FIG. 4B illustrates a flow diagram of the procedure that a user makes changes in his address book according to the present disclosure;

FIG. 5A shows a database schema of the prior art address books;

FIG. 5B shows a database schema of the universal address book according to the present disclosure;

FIG. 6A illustrates a graph representation of the communication and update efforts resulted by the address change in the prior art;

FIG. 6B illustrates a graph representation of the communication and update efforts resulted by the address change in accordance with the present disclosure;

FIG. 7 shows the function modules of the universal address book system;

FIG. 8 illustrates a flow diagram of how the user registers on the universal address book website;

FIG. 9 illustrates a flow diagram of how the user invites his friend to join the network and gets connected with his friend in the network;

FIG. 10 illustrates a flow diagram of how the user queries his friend address from the universal address book system;

FIG. 11 illustrates a flow diagram of how the user queries the friend address via cell phone text message from the universal address book system;

FIG. 12 illustrates a flow diagram of how the user synchronizes his other address books with the online universal address book; and

FIG. 13 illustrates a flow diagram of how the user browses, exports, and prints out his online universal address book via Internet.

### DETAILED DESCRIPTION OF PREFERRED EMBODIMENTS

The present disclosure provides a method and a system for creating, maintaining, and utilizing an online social networking system, which, in a preferred embodiment, is in a format of an online universal address book.

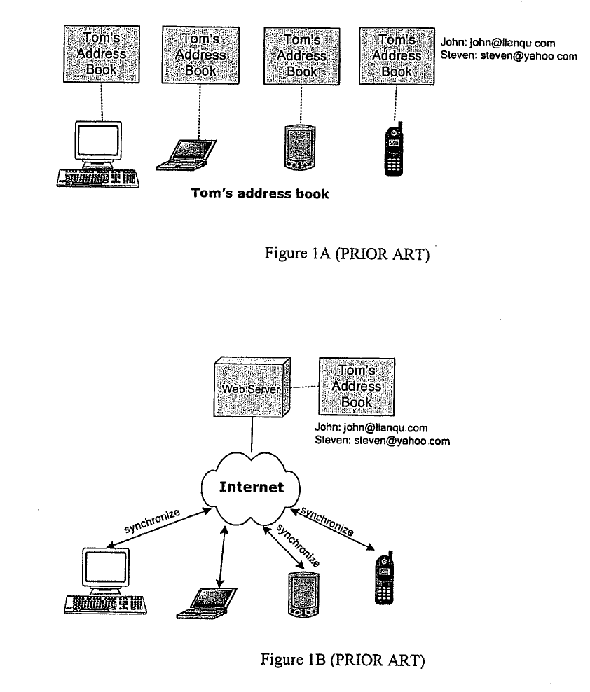

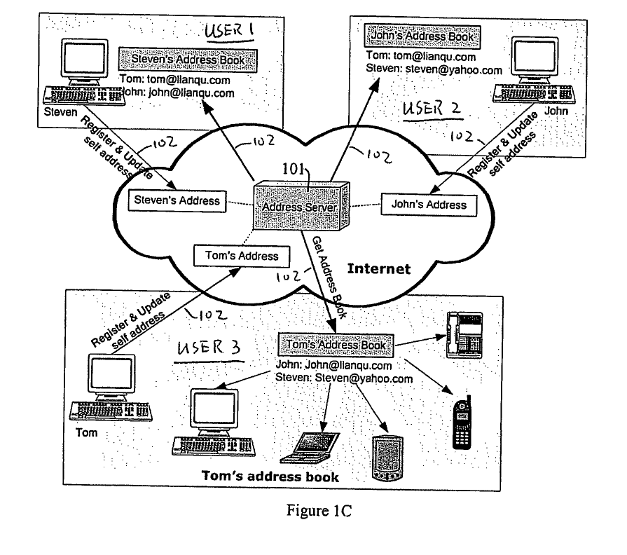

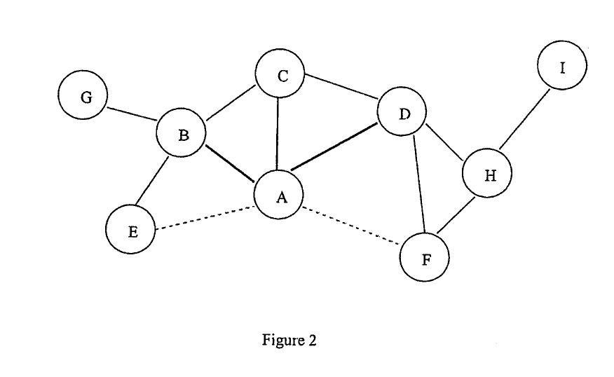

FIG. 1A illustrates traditional formats of a user's (represented by “Tom”) address books, such as address books saved in desktop computer, laptop computer, PDA, and cell phone. Although all the address books may store the same information, they are separated from each other and need to be manually created and maintained one by one. FIG. 1B illustrates a presentation of another prior art information system, which includes a web server. The user (Tom) can save contact information of other people or business entities on the web server and use the web server to synchronize his other digital tools, such as desktop computer, laptop computer, PDA, and cell phone. Similar to the system shown in FIG. 1A, the user still has to be informed of any changes of the contact information and then manually updates the user's address book in the web server.

FIG. 1C shows a diagram of a preferred embodiment in accordance with the present disclosure. Referring to FIG. 1C, the social networking system according to one preferred embodiment of the present invention includes a server 101 and users which communicate with the server 101 over links 102, which may be any medium for transferring data between users and the server. In the present embodiment in FIG. 1C, the links 102 may be connections provided by one or more Internet Service Providers (ISPs) and users may be configured with generic Internet web browsers or server-client structure. The links 102 may be secured or unsecured depending upon the requirements of a particular application.

In accordance with one preferred embodiment, a user, for example, User1, enters his own information which may include but not limited to contact information, photo, marital status, employment information, and etc., over the links 102, e.g. Internet, into the server 101. User2 and User3 may also, with or without User1's invitation, connect to the sever 101 and register on the server, entering their own contact information. Each registered user will have an ID, which can be chosen by the user or assigned by the server. The server automatically creates an address book for each registered user. A registered user (e.g. User1) can invite other registered users (e.g. User2 and User3) to be his “friends”, and upon the acceptance of User2 and User3, User2's and User3's ID will appear on User1's address book or “friend list”, and the IDs are preferably hyperlinked to the database where User2's and User3's registered information is stored. Then User2 and User3 are “directly connected” to User1. When User1 opens his online universal address book, User2's and User3's addresses will be automatically pulled out by server 101. User1's information is also in User2's and User3's address books in the server. Whenever a registered user, for example User 3, changes his contact information, such as changes a new phone or moves to a new place, he only needs to log into the server and update his own information. The new information of User3 will be automatically reflected in other users' address books, which are directly connected to User3, in the above described example, User1's address book. A user always can set up what information is visible to his directly connected “friends”, and what is invisible to the directly connected “friends”.

The user may have several other address books stored in his computer, laptop, PDA or smart cell phone, and he can synchronize these address books with the online universal address book stored in the server 101. The user can also query the information in his address book in server 101 through email, PDA, cell phone or desk phone.

FIG. 2 is a graphic representation of the social network system. In FIG. 2, each node, for example Node A, represents a person or a business entity, and the solid line between two nodes represents that the two entities are directly connected and are in each other's address book. Dotted line means that the two entities, for example, A and E, are directly connected, but not in each other's address book,. Only directly connected friends are the candidates in a user's address book, for example, only B, C, D, E and F can be in A's address book since they are directly connected. G and H are two degrees apart from A, and I is three degrees away, so they are not in A's address book. In the embodiment according to the present disclosure, if they are in each other's address book, the user does not need to enter and update his “friends'” information in his address book, but only needs to maintain his own contact information. His “friends'” contact information will be maintained by themselves and any update of their contact information will be reflected in the user's address book. Thus in the social networking system, a user, e.g. User1, can always have his most up to date contact information reflected on other directly connected users' address book, e.g. User2′ and User3′ address books, and vice versa, User1 can always have User2's and User3's up to date contact information in User1's address book. The address book server 101 is the brain of the system. It will take the user's address input into the database, establish the connection between users, and present the physical address data to the internet user whenever his address book is opened. Furthermore, server 101 will also process the address query and synchronization request from the user. After the user and his “friends” sign up and get connected, from individual point of view, his personal network has been established, however, from system point of view, because generally one user can always be connected to another user through a number of degrees, a huge social network has been built, in which everyone will be directly or indirectly connected to each other eventually.

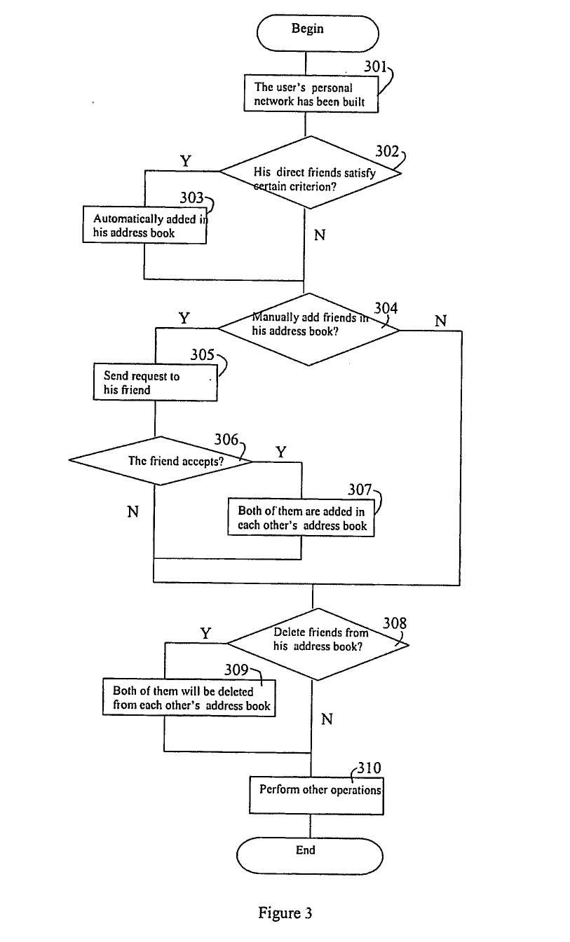

FIG. 3 illustrates a flow diagram of how a user creates and edits his address book. In step 301, a user registers and enters his information into the server 101 (the social networking system), and the system creates an online universal address book for the user. Step 302 is used to facilitate the creation of the data in the user's address book. Based on certain criterion, the system will automatically add the direct friends of the user into the user's address book. For example, the user may want to by default add good friends in, but selectively add new friends. The selection criterion is set by the system designer or can be selected by the user. For example, a user may want to set the selection criterion to be having the same interest and living in the same town. In step 302, if the selection criterion is satisfied, the system continues at step 303, else it goes directly to step 304. In step 303, the selected friends' IDs are automatically added in the user's address book. In step 304, if the user wants to manually add friends in his address book, the process continues at step 305, otherwise, it goes to step 308. In step 305, the user sends a request to a friend he wants to add to his address book. In step 306, if the friend accepts the request, the process continues at step 307, else the friend is not added in the user's address book, in another word, the friend's contact information is still invisible to the user, and the process goes to step 308. In step 307, since the friend accepts the request, both of them are added in each other's address book. In step 308, if the user wants to delete a friend from his address book, the process continues at step 309, else it goes to step 310. In step 309 the user can delete the friend from his address book without the friend's permission. In the mean time, the user's ID or name also will be deleted from this friend's address book, and his friend's ID will be deleted from his address book too. Therefore, if the user does not want a specific friend to get his address information, he can delete this friend's ID or name from the user's address book. In step 310, the user can perform other operations, for example, he might want to set some specific address information (e.g. cell phone number) invisible to in his address book, or set specific information invisible only to particular persons.

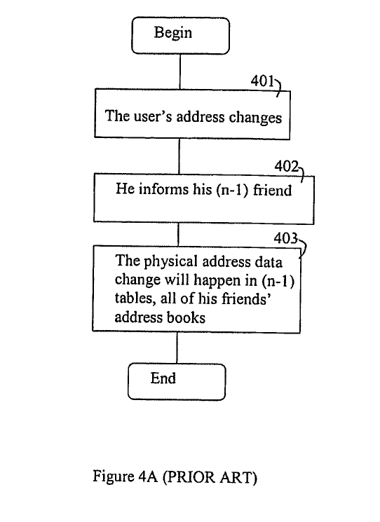

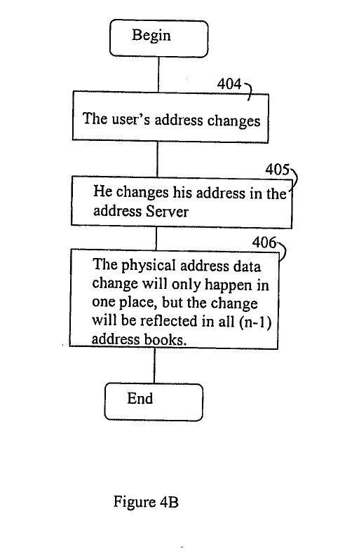

FIG. 4A is a flow diagram of how the user updates his contact information with the traditional approach. In step 401, the user's contact information changes. In step 402, the user informs his (n−1) friends of the new contact information. In step 403, his (n−1) friends get the new contact information and update the user's contact information in their own address books. The physical data change responsive to the change of the user's contact information will happen in (n−1) address tables in the (n−1) friends' address books. FIG. 4B is a flow diagram of how the user updates his contact information according to the present disclosure. In step 404, the user's contact information changes. In step 405, the user logs into the universal address book website and changes his contact information in his address book. In step 406, the physical data change in response to the change of the user's contact information only happens in one place (in the user's address book), but the user's new contact information will be reflected in all (n−1) address books of his (n−1) friends. With the present disclosure, time and storage space are saved for all registered users to update their address books.

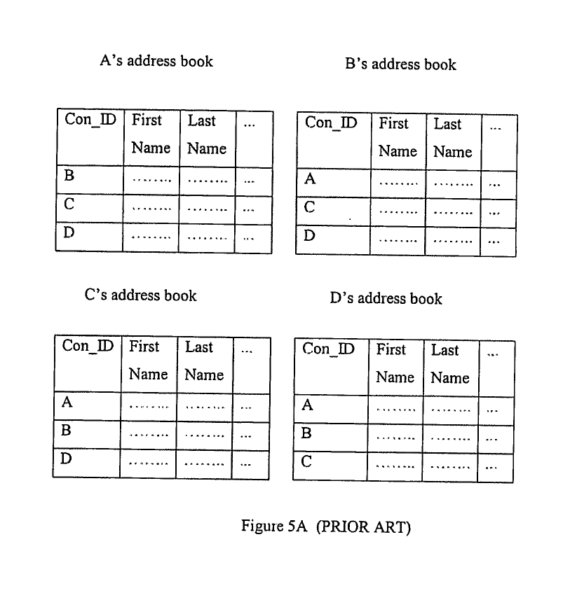

FIG. 5A is an instance of the traditional address books. In the traditional approach, each person's address book is stored in a separate physical table. Therefore, duplicate information is saved in different address books. For example, A, B, C and D's information are stored three times in four address books. Whenever there is a change in one person's contact information, for example, A's contact information, the change has to be physically made in three address books, in this case, B's, C's, and D's address books. If there are n persons in the friend group and everyone has the other (n−1) persons in his address book, n address books (physical tables) will be used to store n(n−1) rows of physical data. Whenever one person changes his contact information (e.g. address), totally (n−1) rows of address data need to be updated to keep all address books up to date. Therefore, if everyone changes his own contact information, all the n(n−1) rows of address data will be changed, in other words, all address data in all address books need to be updated. FIG. 5B is an instance of the universal address book table according to the present disclosure. As seen in FIG. 5B, only two tables are used to hold the data needed by all network users. In FIG. 5B, address table 502 stores the physical address data of each user, and Person-Contact intersection table 501 stores the relationship between the user and his friends. The user's IDs are saved in the Per_ID column, and the user's friends IDs are saved in Con_ID column. Rel_ID is the series number. Table 501 is linked to table 502 through links 503. In the exemplary implementation shown in FIG. 5B, the user's address book is just a presentation layer, and the address data comes from the connection between table 501 and 502. Therefore, each person's address is stored as one row in table 502 no matter how big his friend group is. If a user adds or deletes a friend in his address book, two entries (mutual adding and deleting) will be created or deleted in table 501. For example, if A and B are directly connected, B is in A's address book and A can see B's address by clicking B's Con_ID in A's address book, and B also can see A's address by clicking A's Con_ID in B's address book. If A and B are not directly connected, neither A nor B can see the other's address information. The visibility is controlled by the entry in table 501. When A creates his address book, he adds B, C and D in his address book, so six blocks are created in table 501. While A browses his address book, the system will first query table 501, locate the row with Per_ID=‘A’, find the corresponding Con_ID, which are B,C and D in this case, then join with table 502, and finally, B, C and D's address will be provided in A's address book. A can always get B,C and D's most up to date addresses since the address data in table 502 are maintained by B, C, D themselves, and generally each person will update his own contact information when changes happened. In order to maintain n address books among n friends, the two physical tables 501 and 502 can be used to store n+n(n−1)=n² rows of data, among which n rows store the actual physical address data in table 502, and the other n(n−1) rows store the relationship among the users in table 501. Since table 501 only stores pointers, the storage space is negligible compared to that consumed by the actual physical address data. Whenever one person changes his address, only one row of address data will be changed in table 502. Therefore, n rows in address table will be updated if everyone changes the address. In the other embodiments, more tables can be used for other considerations such as functionality and performance. And different adding or deleting mechanism can be used. For example, one-way adding or deleting.

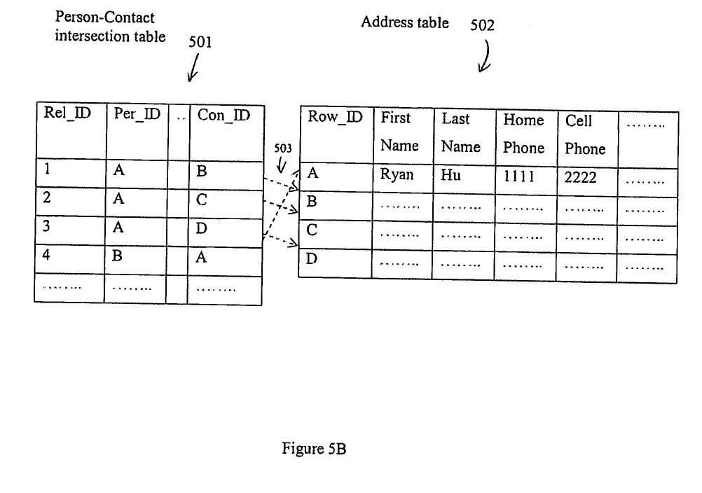

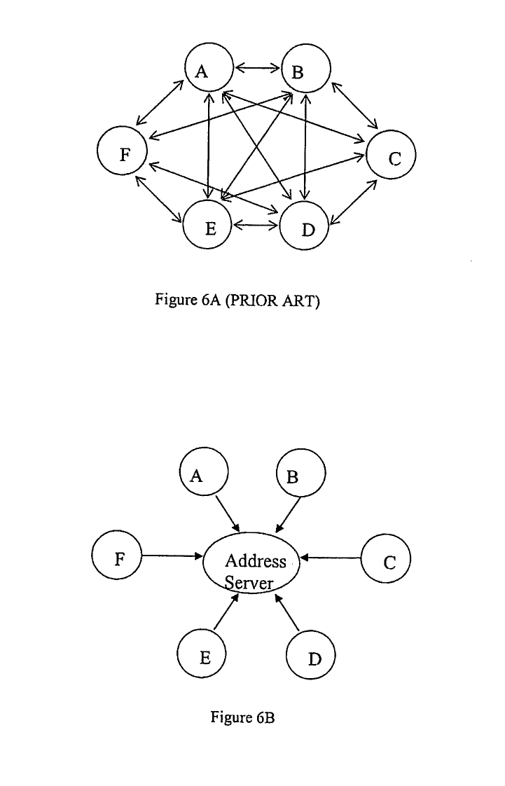

FIGS. 6A and 6B represent the communication and update efforts resulted by the change of the contact information of a user in the traditional address books and in the universal address book according to one preferred form of the present disclosure. The outgoing arrow represents that the user informs his friends of the change of his contact information, and the incoming arrow represents that the user accepts his friend's information and updates the information in his address book. FIG. 6A shows the communication and update efforts resulted by the change of the user's contact information with the traditional approach. As shown in FIG. 6A, in the traditional approach, if the user changes his address, he has to inform all his (n−1) friends, and if all (n−1) friends change their addresses, the user has to be informed, and make (n−1) updates in his address book to reflect the changes. If n people all have new addresses and need to keep their friends' address books up to date, n(n−1) communication and updates will be conducted. FIG. 6B shows the communication and update efforts resulted by the address change with the present invention. Every time, when the user has his new address, he only needs to update his address profile in the universal address book in the server, and the new address will be automatically reflected in his friends' address books. Therefore, if n people all change their addresses, only n times of communication and update between the user and address server are needed. According to the present disclosure, if the user changes his address, he only needs to update the his address profile in the server and his address change will be reflected on his friends' address book, and vice versa, if a friend changes his own addresses, the friend will update his own address profile in the network and the change will reflect on the user's address book. Therefore, the present invention converts the complexity of the address book from O(n²) to O(n), in terms of storage space, update efforts and communication traffics.

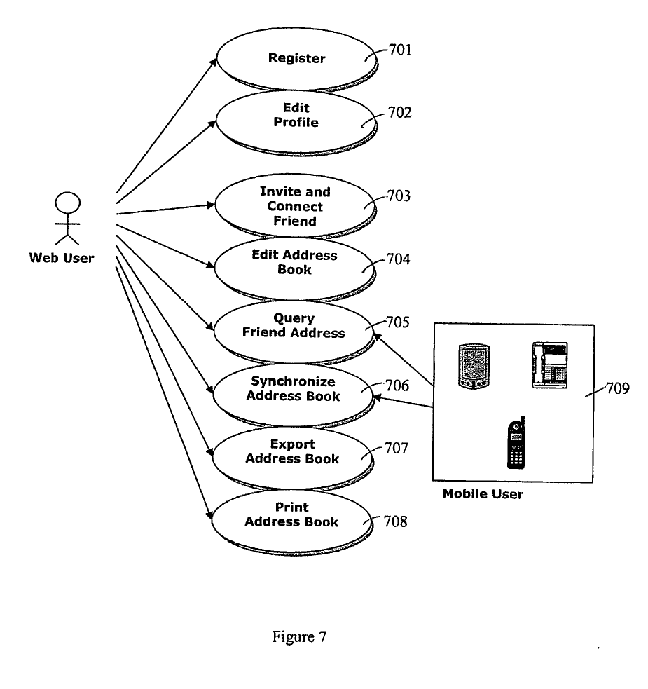

FIG. 7 shows the functional modules of the universal address book system. Module 701 provides the function of registration. Module 702 enables the user to edit his profile including his name, ID, address, and other registration information. Module 703 is used to invite and connect friends. The user can either invite his friends to join or connect the existing users. Module 704 provides the function to edit the address book. The user can add a contact in his friend group into his address book, or delete a contact from his address book. This function will help the user to control that who has the access to his address information. Module 705 is used to query a contacts' address from the sever of the online universal address book system. The query can be done through email, PDA, cell phone, or regular phone. Module 706 is used to synchronize address books stored in other places with the universal address book. Module 707 is used to export the universal address book into different format of files such as Microsoft outlook, Palm desktop, Yahoo! CSV, and etc., so that the address book can be later imported into the other applications. Module 708 provides the function to print out the universal address book. Module 705 and 706 can be used by mobile users 709 so that the address book can be accessed by wireless means.

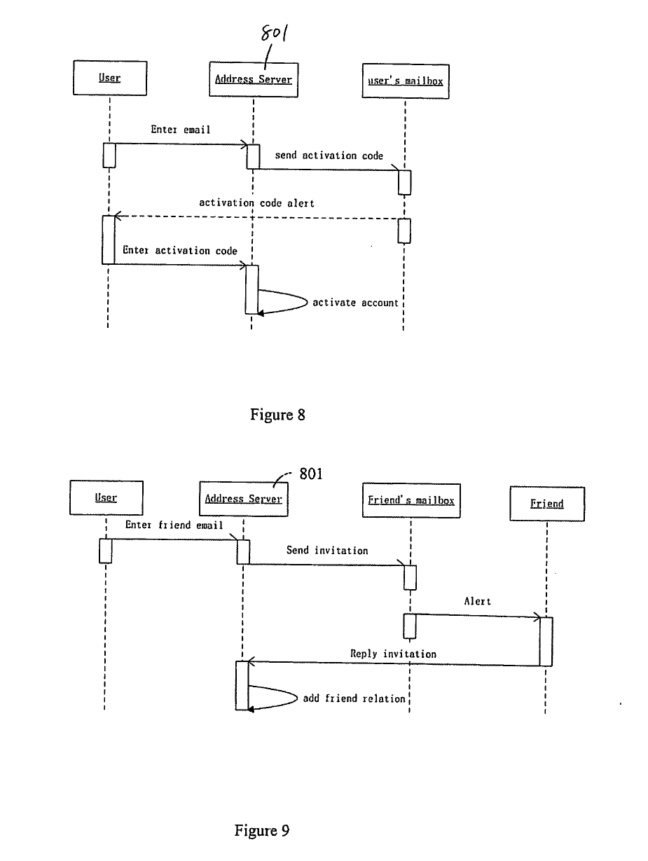

FIG. 8 illustrates a process of how the system handles a user's registration through the Internet. The system receives the user's registration, which include the user's information, such as address and phone numbers etc., and create an address profile for the user. After the registration, address server 801 will automatically send the user a confirmation email, which includes an activation code or password. The activation code is used for security reason since someone else might use the user's email to register. The user can sign in into the system using an ID (e.g., the user's email address) and the password, and then change information in his account.

FIG. 9 illustrates a process of how the system creates connections between users. Upon a user's request for direct connection with another user, for example User1 requesting to be directly connected to User2, the system will send an invitation associated with User1's ID to User2, and upon User2's acceptance, the system will create a direct link between User1 and User2, as described above and shown in FIG. 5B. The system may also send out invitations to addresses specified by a registered user. For example, registered User1 sends out email invitation through the social networking system to a non-registered friend, Non-User4. After receiving the invitation, Non-User4 may register on the social networking system, and specify that User1 invites him to enter a directly connected relationship. Upon receiving Non-User4's application, the system may create a direct connection between User1 and Non-User4 (Non-User4 becomes a registered user now). The social networking system may also provide a circumstance that allows a user to search information of other users, and invite other users to be his directly connected friend. In one preferred form, the system provides links between users under directly connected relationship, so that they can view each other's address profile, which has been classified by the user to be visible, and users who are not under directly connected relationship cannot view each other's address profile. In an alternative form, the system may provide a circumstance allowing users who are less than n degrees apart (n could be more than 1) to have the authority to view each other's address profile.

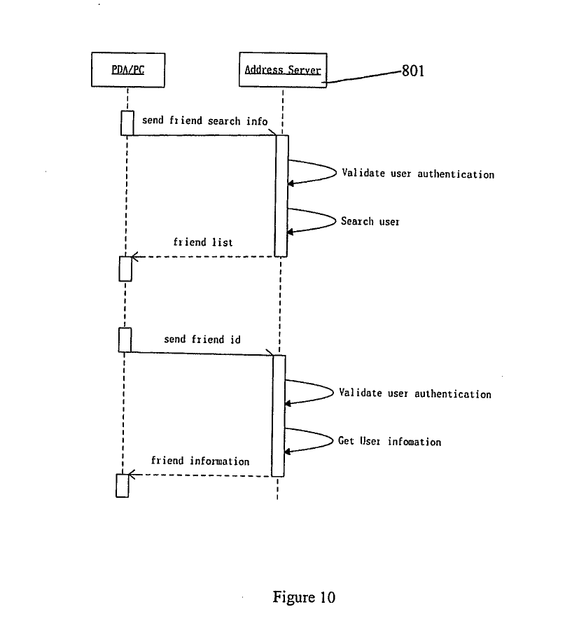

FIG. 10 illustrates a process of how the social networking system handles the user's queries, for example, a friend's contact information, in his address book. After the system (the server 801) receives the user's request and verifies the user's authentication, the system searches and finds the information the user needs in the database, and sends the information to the user. If the search result is multiple or zero, the system may send a list of the multiple results (e.g. a list of founded friends' names or IDs) or a “not found” message to the user. Then the user may choose one ID and sends the friend's ID back or sends a correct ID or friend's name back to the system. After the system receives the second query, the system will repeat the same verification procedure and finally return the needed contact information to the user. The query process can be done via desk phone, desk computer, or other channels, for example, wireless means.

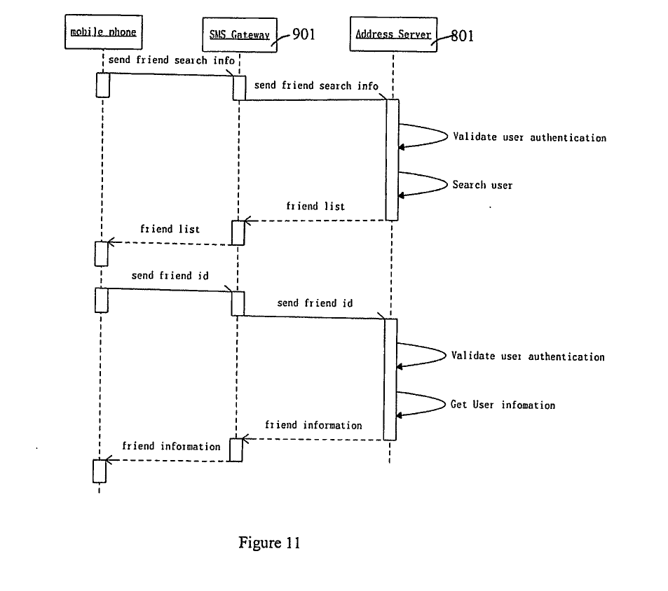

FIG. 11 illustrates a process of how the social networking system handles the user's queries of his friend's address via mobile short text message. In one preferred embodiment, the system includes a server 801 and a Short Message Service (SMS) gateway 901. After the system receives the text message request from the user, the search request is routed to the address server 801 via Short Message Service (SMS) gateway 901. After the server 801 verifies the user and his contact information, the system will send back the query result via gateway 901. If only one result is found, the system will send the search result to the user. If multiple results are found associated with the search query, the system will send a result list, which could be a list of IDs or names, and after the user selects one from the list and sends the query to the system again, the system will repeat the process described above. If there is no result, the system will send to the user a “not found” error message.

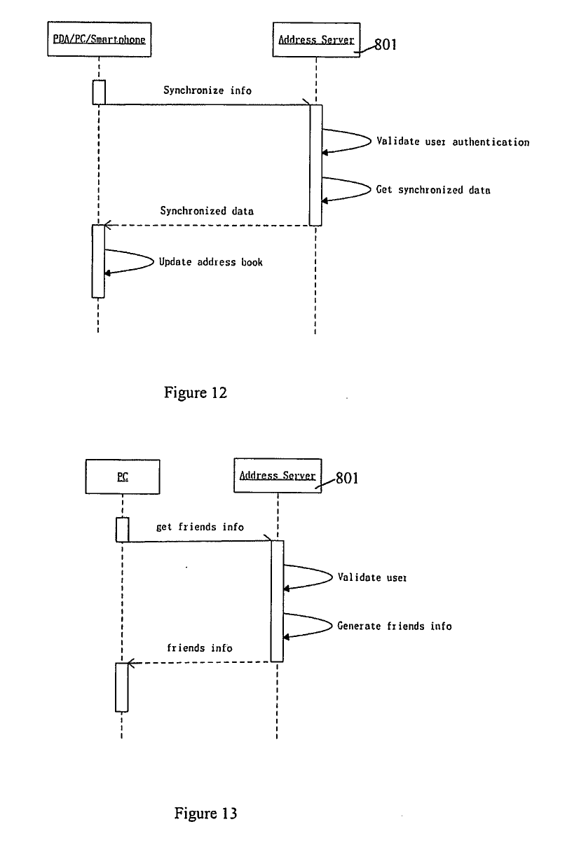

FIG. 12 illustrates a process of how the social networking system synchronizes a user's other address books with the online universal address book. In one preferred embodiment, after the system receives the user's synchronization request to the address server 801, the server 801 verifies the user's authentication, and generates synchronized data, and then send the synchronized data to the user. The user then can use the returned data to synchronize his other address books, such as address books saved in cell phone, PDA, computer, and etc.

FIG. 13 illustrates a process of how the user browses, exports, or prints out his online universal address book via Internet. First, the user logs into the universal address book website through his internet browser. Then the server 801 verifies the user's authentication. When the user opens his address book, the server 801 will retrieve all his contacts' address information from the database and present them in the address book. Now the user can browse his address book, export all or part of his friends' contact information to a specific text format, or print it out.

The above description describes the exemplary embodiments in accordance with the present disclosure. Person skilled in the art should understand that the social networking system according to the present disclosure should not be limited to be used among “friends”, it also can be used in business relationships, and the social networking system should not be limited to communication of any particular information such as address, and contact information as described in the exemplary embodiments, the system should be applicable to any information.

The present disclosure may be embodied in other specific forms and embodiments without departing from the spirit or essential characteristics thereof. The exemplary embodiments shown in the present specification are, therefore, to be considered in all respects illustrative and not restrictive, of the scope of the present disclosure, and all changes which come within the meaning and range of equivalency of the exemplary embodiments are therefore intended to be embraced within the present disclosure.

1. A method of creating and maintaining a social network system using a computer system, said method comprising:
receiving registration in said computer system from users, said registration containing information of said users;
sending invitation initiated by a user A to another user specified by said user A;
determining whether said another user accepts said invitation from said user A; and
if said another user accepts said invitation, creating at least one direct link between said user A and said another user, wherein said direct link allows said two users to access each other's information.

2. A method of creating and maintaining a social network system according to claim 1, wherein said information including visible information and invisible information specified by the users, and wherein said direct link allows said users to access each other's visible information.

3. A method of creating and maintaining a social network system according to claim 1, wherein said information comprises contact information.

4. A method of creating and maintaining a social network system according to claim 1, wherein said information of other users that are directly linked to said user A are saved in a format of an address book, which can be accessed by said user A.

5. A method of creating and maintaining a social network system according to claim 4, wherein said method further comprises deleting a user's information from said address book of said user A, said deleting being initiated by said user A.

6. A method of creating and maintaining a social network system according to claim 5, wherein said method further comprises deleting said user A's information from said user's address book, wherein said user is the user deleted from said user A's address book initiated by user A.

7. A method of creating and maintaining a social network system according to claim 4, wherein said other users includes a user B, wherein said method further comprises editing said user B's information by said user B, wherein said edited information being reflected in said user A's address book.

8. A method of creating and maintaining a social network system according to claim 4, wherein said method further comprises a method of processing a user's query of information in said user's address book, said method of processing a user's query comprising:
receiving a user's query of information in said user's address book and said user's identity authentication;
verifying said user's identity authentication;
searching said information requested by said user in said user's address book; and
sending search result information to said user.

9. A method of creating and maintaining a social network system according to claim 8, wherein said step of receiving said user's query is conducted through Internet.

10. A method of creating and maintaining a social network system according to claim 8, wherein said step of receiving said user's query is conducted through wireless means.

11. A method of creating and maintaining a social network system according to claim 8, wherein said step of receiving said user's query is conducted through mobile phone system.

12. A method of creating and maintaining a social network system according to claim 11, wherein said step of receiving said user's query is conducted through text message system of said mobile phone system.

13. A method of creating and maintaining a social network system according to claim 8, wherein said step of receiving said user's query is conducted through a phone system.

14. A method of creating and maintaining a social network system according to claim 4, wherein said method further comprises a method of synchronizing a user's address book saved in a digital tool, said method of synchronizing comprising:
receiving a synchronization request and an identity authentication from a user;
verifying said identity authentication;
creating synchronized data based on said user's address book in said social network system; and
sending said synchronized data to said user.

15. A method of creating and maintaining a social network system using a computer system, said method comprising:
receiving registration from users in said computer system, said registration containing information of said users;
sending invitation initiated by a first user to a non-registered third party specified by said first user;
receiving registration from said non-registered third party;
determining whether said registration of said third party specifies said first user as a link candidate; and
if said third party specifies said first user as a link candidate, creating a direct link between said first user and said third party, wherein said direct link allows said first user and third party to access each other's information.

16. A method of creating and maintaining a social network system according to claim 15, wherein said information including visible information and invisible information specified by the users, and wherein said direct link allows said first user and said third party to access each other's visible information after said third party's registration.

17. A method of creating and maintaining a social network system according to claim 15, wherein said information comprises contact information.

18. A method of creating and maintaining a social network system according to claim 15, wherein said information said third party that is directly linked to said first user is saved in a format of an address book, which can be accessed by said first user.

19. A method of creating and maintaining a social network system according to claim 18, wherein said method further comprises editing said first user's or said third party's information by said first user or said third party, wherein said edited information being reflected in said first user's address book or said third party's address book.

20. A method of creating and maintaining a social network system according to claim 18, wherein said method further comprises a method of processing a user's query of information in said user's address book, said method of processing a user's query comprising:
receiving a user's query of information in said user's address book and said user's identity authentication;
verifying said user's identity authentication;
searching said information requested by said user in said user's address book; and
sending search result information to said user.

22. A method of creating and maintaining a social network system according to claim 18, wherein said method further comprises a method of synchronizing a user's address book saved in a digital tool, said method of synchronizing comprising:
receiving a synchronization request and an identity authentication from a user;
verifying said identity authentication;
creating synchronized data based on said user's address book in said social network system; and
sending said synchronized data to said user.

23. A method of creating and maintaining a social network system using a computer system, said method comprising:
constructing a first database table, said first database including identification information;
constructing a second database table for storing information of a user, wherein said second database is connected to said first database;
receiving registration from users in said computer system, said registration containing information of said users, wherein said information includes identification information and contact information, wherein said identification information is saved in said first database table and said contact information is saved in said second database table;
sending invitation initiated by a first user to a non-registered third party specified by said first user;
receiving registration from said non-registered third party;
determining whether said registration of said third party specifies said first user as a link candidate; and
if said third party specifies said first user as a link candidate, creating a direct link between said first user and said third party in said first database table, wherein said direct link allows said first user and third party to access each other's contact information in said second database table through said first database table.

24. A method of creating and maintaining a social network system using a computer system according to claim 23, wherein said method further comprises creating a list of users for a user B, wherein said users in said list are connected by said links to said user B.

25. A method of creating and maintaining a social network system using a computer system according to claim 24, wherein said list contains identification information of said users that are connected by said links to said user B.

26. A method of creating and maintaining a social network system using a computer system according to claim 25, wherein said list further comprising contact information of said users that are connected by said links to said user B, wherein said list is in a format of an address book.

27. A method of creating and maintaining a social network system using a computer system according to claim 26, wherein said method further comprises amending a user's information initiated by said user, wherein said user is connected to said user B by said link, wherein said amended information is reflected in said user B's address book.

28. An apparatus for maintaining a social network system comprising:
one or more processors; and
a memory communicatively coupled to said one or more processors, the memory including one or more sequences of one or more instructions which, when executed by said one or more processors, cause said one or more processors to perform the steps of:
receiving registration in said computer system from users, said registration containing information of said users;
sending invitation initiated by a user A to another user specified by said user A;
determining whether said another user accepts said invitation from said user A; and
if said another user accepts said invitation, creating at least one direct link between said user A and said another user, wherein said direct link allows said two users to access each other's information.

29. A method of creating and maintaining a social network system using a computer system according to claim 28, wherein said steps further comprises creating a list of users for a user B, wherein said users in said list are connected by said links to said user B, wherein said list contains identification information and contact information of said users, wherein said list is in a format of an address book.

30. A method of creating and maintaining a social network system using a computer system according to claim 29, wherein said steps further comprises amending a user's information initiated by said user, wherein said user is connected to said user B by said link, wherein said amended information is reflected in said user B's address book.

31. A system for maintaining a social network system comprising:
a computer system including a processor and associated memory, said computer system including a first database table for storing a user's identification information and relationship information between any two users, and a second database table for storing a user's contact information, wherein said first database table and said second database table are connected;
communication links for connecting users to said computer system, wherein said users register through said communication links in said computer system, wherein said computer system creates a direct link between two users upon request by at least one user and acceptance by the other user, said direct link being saved in said first database table, wherein said direct link allows said two users to access contact information of the other user saved in said second database table.

32. A system for maintaining a social network system according to claim 31, wherein said computer system is adapted to create a list of users for a user B, wherein said users in said list are connected by said links to said user B, wherein said list contains identification information and contact information of said users, wherein said list is in a format of an address book.

33. A system for maintaining a social network system according to claim 31, wherein said computer system is adapted to amend a user's information initiated by said user, wherein said user is connected to said user B by said link, wherein said amended information is reflected in said user B's address book.
